(19) United States
(12) Patent Application Publication
(10) Pub. No.: US 2004/0143950 A1
(43) Pub. Date: Jul. 29, 2004

(54) Slide hammer

(76) Inventor: Michael Antoniades, Scarborough (CA)

Correspondence Address: MILLER THOMPSON, LLP, 20 QUEEN STREET WEST, SUITE 2500, TORONTO, ON, M5H 3S1, CA

(21) Appl. No.: 10/351,346

(22) Filed: Jan. 27, 2003

(51) Int. Cl. B23P 19/00

(52) U.S. Cl. 29/426.5; 29/254

(57) ABSTRACT

A tool for extracting a pin from a hole, comprising a shaft having a first and second end; a stop at first said end; removable securing means associated with said second end to secure a selected pin removal means at said second end for engagement with said pin; a handle slideably movable along said shaft to strike said stop and urge said pin out of said hole.

### FIELD OF INVENTION

This invention relates to an extraction tool, and particularly to a tool for extracting a pin from a hole as well as extracting inserts from a die mould. Moreover this invention relates to a method for removing pins from a hole and in one embodiment includes removing a pin from a blind hole.

### BACKGROUND ART

Pins or dowels are commonly inserted into holes for locating or securing one part relative another in a variety of fields including tool and die making.

The tool and die industry commonly has a need to locate a die mould on a machine table or to locate an upper die relative a lower die. Furthermore it is not unusual to include an insert into the die having a recess adapted to receive said insert. The insert can be located or secured to the die body or mould by means of pins or the like. Once the insert has been worn or needs to be replaced it is necessary to remove these pins, dowels or the like so as to replace the insert.

The pins or dowels are generally received by holes having tight tolerances to receive the pins, such holes extending between the die and supporting table or insert and die mould. Many of these holes are blind holes which will not accommodate simply striking the pin out of the hole by means of inserting a rod and striking the rod with a hammer; since there is only one entry into the hole. In these circumstances tool and die makers utilize pins or dowels or other securing means having at one end thereof an internally threaded hole which is adapted to be engageable with an externally threaded portion presented by a pin removal tool.

Many of these pin removal tools have sliding hammers. For example, U.S. Pat. No. 5,984,272 relates to a tool for extracting headed nails. The tool includes pliers having a handle, locking lever and first and second pivotally connected jaws each with distal ends. The tool further includes a slide hammer mechanism including a rod having first and second ends and a hammer member mounted to slide along the rod, and wherein the rod is connected at the first end with the pliers and has a stop at the second end.

Moreover U.S. Pat. No. 5,090,112 illustrates a tool for removing a diesel injector sleeve from a diesel engine head. The tool comprises of a split, threaded expander section within which is mounted a plunger having an angled end. The plunger is part of an extension handle upon which slides a weighted hammer section. The tool is inserted into the neck of an injector tube. The downward blow with the hammer drives that expander over the plunger, expanding the threads into the said wall of the tube and creating a positive connection with the injector tube.

U.S. Pat. No. 4,443,922 relates to a tool for extracting an object having a central circular opening, from an assembled arrangement, said such as a low and reverse gear clutch housing from a planetary gear arrangement.

Furthermore U.S. Pat. No. 4,285,123 illustrates a tool for removing a pin from a support where the pin is formed with a portion extending laterally from the axis thereof.

U.S. Pat. No. 4,263,705 illustrates a hand tool for removing dowel pins from a tool block comprising a commercially available adjustable locking type of pliers modified by special jaws and the addition of a jack mechanism.

Another device which is used in the tool and die industry for extracting pins or dowels from a hole comprises utilizing a sliding hammer mechanism which is comprised of a shaft with a stop at one end and an internally threaded hole at the other end for receiving one threaded end of two bolts which are welded together at the two heads. Therefore when one wishes to remove a dowel from a blind hole, an appropriately sized bolt is selected so as to engage the internal threads of the dowel while the opposite end of the two welded bolts is received internally into the internal threads of the tool. Thereafter the hammer is used to strike the stop so as to withdraw the dowel from the hole. However, such tool presents a number of disadvantages including breaking of the welded bolts, as well as the awkward nature of utilizing a different sized bolt for a smaller or larger dowel having a different size internal threaded hole.

It is an object of this invention to provide an improved tool for extracting pins or the like from a hole.

It is another object of this invention to provide a method of extracting a pin or the like from a blind hole in a mould.

### DISCLOSURE OF INVENTION

It is an aspect of this invention to provide a tool for extracting a pin from a hole, comprising a shaft having a first and second end; a stop at first said end; removable securing means associated with said second end to secure a selected pin removal means at said second end for engagement with said pin; a handle slideably movable along said shaft to strike said stop and urge said pin out of said hole.

It is a further aspect of this invention to provide a method of extracting a dowel from a hole, said dowel having an internally threaded portion comprising the steps of selecting a bolt having a head and exterior threads capable of engagement with said internally threaded dowel; securing said bolt to a tool having a shaft and slideable hammer, said shaft having a stop at one end and an externally threaded second end engageable with a connector, said connector clamping said head of said bolt to said second end; inserting said external threads of said bolt into said hole for engagement with said internal threads of said dowel; sliding said handle against said stop repeatedly for withdrawing said dowel from said hole.

It is yet another aspect of this invention to provide a method of removing an insert block from a die mould recess, wherein said insert block is located and secured to said mould recess by means of a connecting bolt extending through aligned threaded holes in said insert block and said die mould, said insert also including withdrawing threaded holes comprising the steps of selecting a bolt having an head and an external thread capable of engagement with said withdrawing threaded hole in said insert block; securing said bolt to a tool having a shaft and slideable hammer, said shaft having a stop at one end and an externally threaded second end engageable with a connector, said connector clamping said head of said bolt to said second end; inserting said external thread of said bolt into said withdrawing threaded hole in said insert block for engagement with said withdrawing threads of said insert block; striking said handle against said stop repeatedly for withdrawing said insert so as to remove said insert from said die mould.

### BRIEF DESCRIPTION OF DRAWINGS

FIG. 1 is an exploded view of one embodiment of the extraction tool.

FIG. 2 is a side elevational view of the removable securing means.

FIG. 3 is a side elevational view of an assembled extraction tool in one position.

FIG. 4 is a side elevational view of the assembled extraction tool with the hammer in a first striking position.

FIG. 5 is a side elevational view of an assembled tool with the hammer in a second striking position.

FIG. 6 is a partial cross-sectional view of the tool used to extract a pin from a hole in a blind hole of a table.

FIGS. 7a and 7b are partial cross-sectional views of the tool for extracting a pin from an insert.

FIG. 8 is a top plan view of the insert shown in FIG. 7.

FIG. 9 illustrates a plurality of pin removal means.

FIG. 10 illustrates another embodiment of the invention.

### BEST MODE FOR CARRYING OUT THE INVENTION

In the description that follows, like parts are marked throughout the specification and the drawings with the same respective reference numerals. The drawings are not necessarily to scale and in some instances proportions may have been exaggerated in order to more clearly depict certain features of the invention.

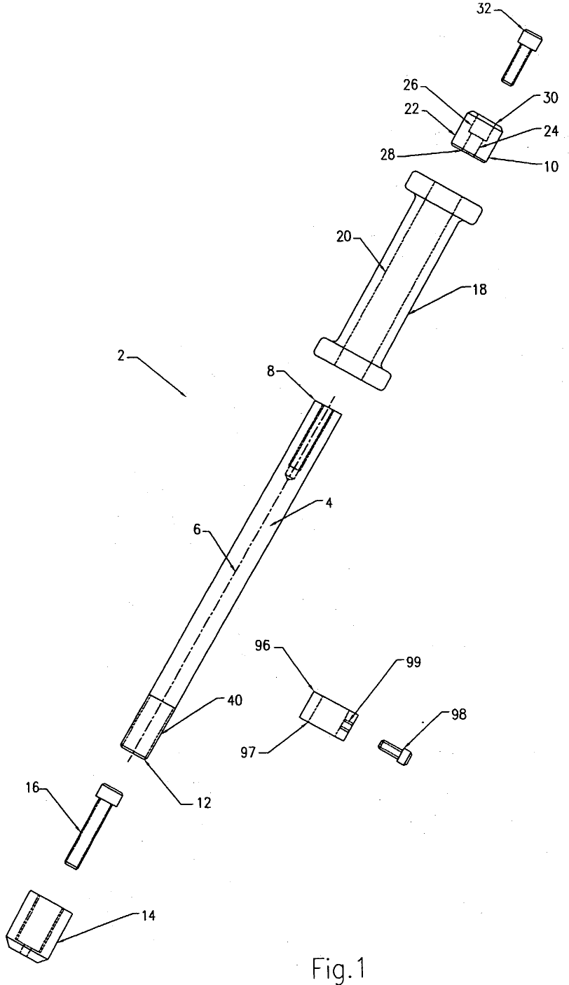

FIG. 1 is an exploded view of a tool 2 having a shaft 4 extending along an axis 6 so as to present a first end 8 having a stop 10 at the end thereof and a second end 12 with a removable securing means 14 associated with the second end 12 to secure a selected pin removal means 16.

More specifically the tool 2 also includes a handle 18 having a bore 20 there through adapted to slideably receive the shaft 6. The inner diameter of the bore 20 is selected so as to present relatively easy movement between the handle 18 and shaft 6 with very little play.

The stop 10 comprises a generally cylindrical body 22 having a bore 24 there through, where the bore 24 presents a first opening 26 which is larger than the second opening 28 so as to present a shoulder 30 adapted to receive and embrace a bolt 32 as best seen in FIG. 1. In other words, the stop 10 includes a counter bore.

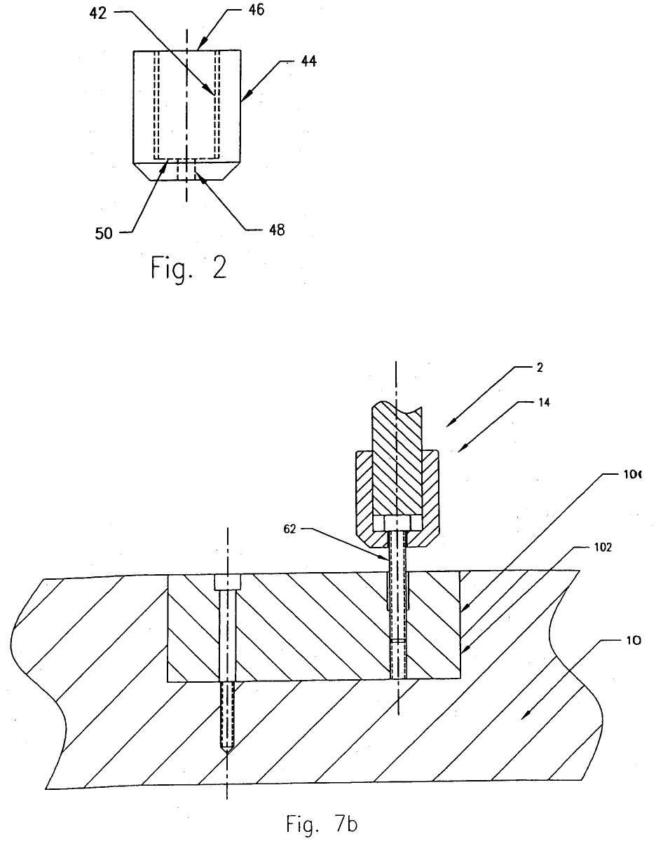

The second end 12 of the shaft 6 includes an external thread 40 adapted to engage the removable securing means 14 in a manner to be described herein. In particular the removable securing means 14 as shown in FIG. 2 includes an internal thread 42. In one embodiment the removable securing means 14 comprises a connector 44 having a connector hole 46 for receiving the threads of the pin removal means as shown in FIG. 9. In particular the thread removal means comprise a plurality of bolts having different size external threads 62 and head sizes 64.

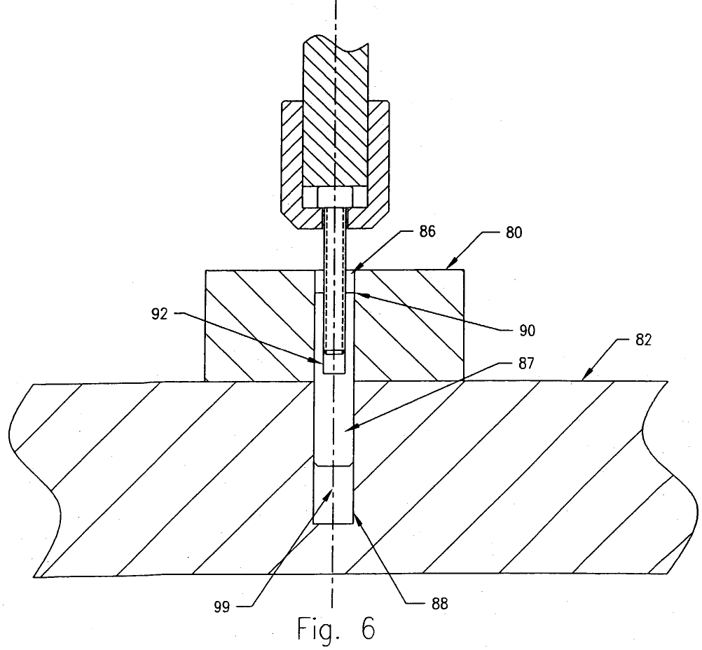

The connector 44 is adapted to receive the external threads 62 of the bolt 60 by placing the thread 62 into the connector hole 46 so as to extend through the hole as shown in FIGS. 3, 4, 5 and 6. More specifically the connector 44 includes two different size holes 46 and 48 where the connector hole 46 is adapted to receive the head 64 of the bolt so as to bear against the shoulder 50 presented by the connector. In other words, the hole 48 of the connector receives the threaded end 62 of the bolt while the shoulder 50 contacts the head 64 of the bolt. Furthermore the internal threads 42 of the connector are adapted to engage the external threads 40 of the shaft 6 as best illustrated in FIG. 6 so as to clamp the head of the bolt 64 between the second end 12 of the shaft and the shoulder 50 of the connector. The exterior surface of the connector 44 can be knurled (not shown) so as to assist in gripping the connector and providing easy torque. In this way the connector 44 embraces the second end 12 of the shaft 6.

FIG. 6 shows the use of the extraction tool 2 in one embodiment whereby a die 80 rests on top a machine table 82. In many applications in tool and die making the die 80 must be accurately placed relative the machine table 82. This can be accomplished by utilizing a pin or dowel 87 which extends through a hole 86 located in the die 80 and extends in an aligned axial position through a hole 88 located in the machine table. The aligned hole 88 may be a blind hole as shown in FIG. 6. Accordingly it is not possible to “tap out” the pin 87 from the hole 86 and 88 by using a tapping tool (tapping the bottom of the dowel 84 so as to extract the pin out of the hole 86). Accordingly the tool 2 as described herein can be utilized so as to extract the pin, dowel or the like from the blind hole.

The pin, dowel or the like has at one end thereof 90 an internally threaded hole or female threaded hole 92. Accordingly the die 80 can be accurately located relative a table 82 and a hole 86 drilled through the die 80 so as to align with a hole 88 in the table of the machine. The holes 86 and 88 are accurately machined and co-axially aligned along an axis 94 so as to receive the pin 84. Generally speaking there is a very tight friction fit between the pin 87 and the holes 86 and 88 so that there is very little “play” of the die 80 relative the tabletop 82. Accordingly when it is necessary to remove the pin 87, the appropriate sized bolt 60 can be selected so as to threadably engage with the internal threads 92 of the pin, dowel or the like 87. The appropriately sized bolt 60 is secured to the second end 12 of the shaft 6 as described above. Thereafter the end of the bolt 62 is inserted into the hole 86 so as to threadably engage the internal threads 92 of the dowel 87. Thereafter handle 18 is moved axially along the shaft 6 in the manner shown in FIGS. 3, 4, and 5 so as to strike against the stop 10 so as to urge the pin 87 out of the hole 86.

In one embodiment a collar 96 having a hole 97 extending there through is removeably attached to the outside diameter of the shaft 6. In particular the hole 97 is sized so as to receive the shaft 6. The collar 96 also includes a radially extending hole 99 extending into the hole 97 so as to receive a screw 98 for securing the collar 96 against the shaft 6 in the vicinity of the second end 12. The removable collar 96 can be utilized so as to inhibit the handle 18 from sliding off the shaft 6 when the removable securing means 14 is removed from the second end 12 of the shaft. Furthermore the collar 96 is also used to prevent the hammer 18 from hitting the removable securing means and ultimately damaging same.

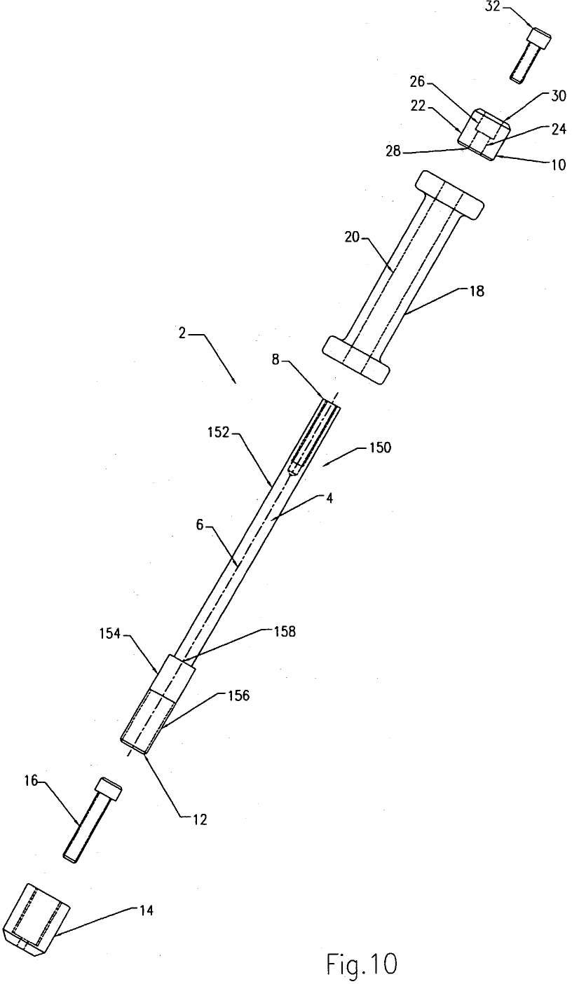

Another embodiment of the collar is shown in FIG. 10. More specifically the shaft 4 includes a first portion 150 having a first diameter 152 in the region of the first end 8: and a second portion 154 having a second diameter in the region of another end 12. Therefore a shoulder 158 is presented which acts in a similar fashion to collar 96, namely to prevent the handle from hitting the removeable securing means and ultimately damaging same. In other words the first portion 150 has a diameter selected to slidingly receive the bore 20 of handle 18, while the second portion is selected to have a diameter which is larger than the inner diameter of the bore 20. Moreover such embodiment is easy to manufacture and presents a shoulder 158 which prevents or inhibits the handle from sliding off the second end 12.

Furthermore in the embodiment shown in FIG. 10 the first portion 150 can include a knurled portion (not shown) so as to facilitate holding the shaft 4 at the end 8. The diameter of the knurled portion is less than the inner diameter of the bore 20 of handle 18.

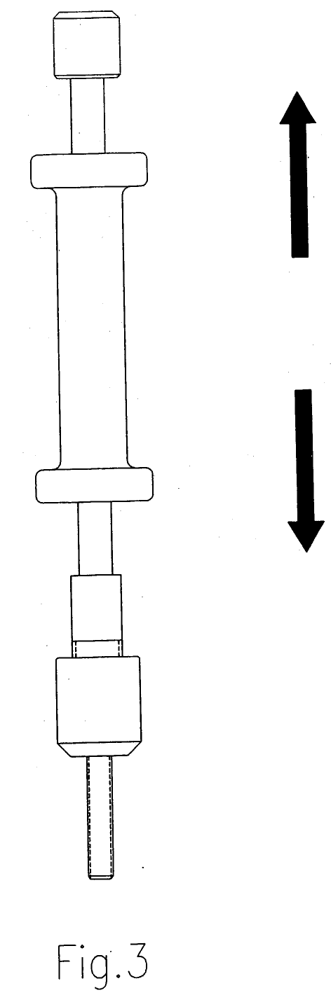

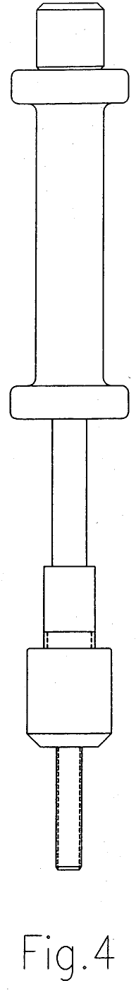

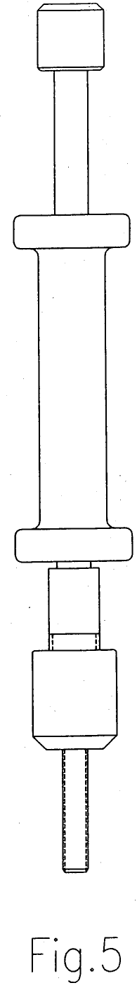

The hammer 18 can be moved to a first striking position as shown in FIG. 4 whereby the hammer 18 strikes the stop 30. The hammer 18 can also be moved to a second striking position as shown in FIG. 5 whereby the hammer strikes the removable collar 96 or the collar or shoulder 158 shown in FIG. 10, so as to create a force opposite in direction to that shown in FIG. 4. In other words, FIG. 5 shows an example whereby a pin can be inserted into a hole. FIG. 4 illustrates the use of the sliding hammer in removing a pin.

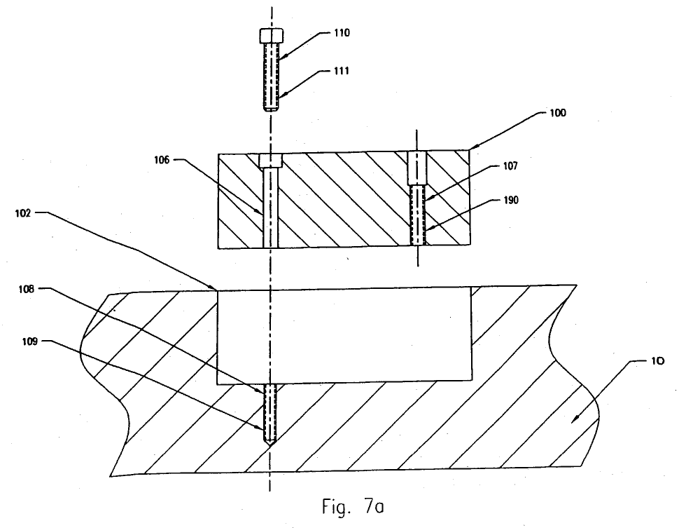

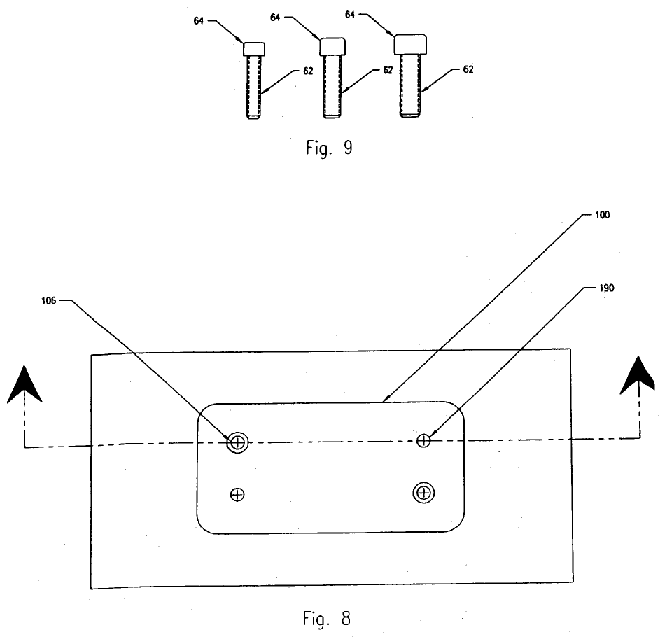

FIGS. 7a and 7b show an alternate embodiment whereby an insert 100 is received by an appropriate recess 102 located in a die 104. The insert 100 can include a plurality of holes 106 which are not threaded and which extend through the insert 100 and co-axially align with a hole 108 located in the mould; and which hole 108 is threaded at 109. A fastener 110 such as a threaded connecting bolt 111 can be inserted into the holes 106 and threaded into hole 108 so as to accurately align, locate and secure the insert 100 relative to the die 104. Generally speaking there is a tight tolerance between the insert 100 and the recess 102 of for example +/−0.0005 of an inch. Therefore it is generally difficult to remove the insert 100 from the recess 102. However by using the tool 2 described herein such task can be simplified. Therefore withdrawing holes 190 in insert 100 are used to withdraw the insert. The withdrawing holes 190 are threaded at 107 and are adapted to threadedly receive the threads 62 of pin removal means 16. For example the connecting bolt 111 can be removed by an appropriate tool such as a ratchet wrench (not shown).

Furthermore if two or more holes are used two tools 2 may be utilized which are engageable with the internal threads 107 of the insert 100 whereby the external threads 62 of the removable securing means 14 are threaded to the internal threads 107 of the insert 100 so that the insert 100 can be removed from the recess 102 by utilizing two tools when two threaded holes 107 are utilized and striking the stops substantially simultaneously as previously described.

The invention herein describes a method of extracting an internally threaded dowel from a hole which comprises the steps of:

(a) selecting a bolt having a head and an external thread capable of engagement with the internally threaded dowel;

(b) securing the bolt to a tool having a shaft and a slideable hammer, the shaft having a stop at one end and an externally threaded second end engageable with a connector, where the connector clamps the head of the bolt to the second end;

(c) inserting the external threads of the bolt into the hole for engagement with the internal threads of the dowel;

(d) striking the handle against the stop repeatedly for withdrawing the dowel from the hole.

Alternatively the invention described herein can be utilized to remove an insert 100 from a recess 102 by utilizing the tool described herein and engaging the threads 62 of the of the bolt 60 with the internal threads 107 of the insert 100.

Various embodiments of the invention have now been described in detail. Since changes in and/or additions to the above-described best mode may be made without departing from the nature, spirit or scope of the invention, the invention is not to be limited to said details.

I claim:

1. A tool for extracting a pin from a hole, comprising:
(a) a shaft having a first and second end;
(b) a stop at first said end;
(c) removable securing means associated with said second end to secure a selected pin removal means at said second end for engagement with said pin;
(d) a handle slideably movable along said shaft to strike said stop and urge said pin out of said hole.

2. A tool as claimed in claim 1 wherein said removable securing means is rotatably engageable with said second end of said shaft.

3. A tool as claimed in claim 1 wherein said removable securing means comprises a connector adapted to embrace said second end of said shaft.

4. A tool as claimed in claim 3 wherein said second end includes exterior threads, and said connector includes interior threads engageable with said exterior threads of said second end.

5. A tool as claimed in claim 4 wherein said pin removal means comprises a bolt having a selected thread and head, and said connector includes:
(a) a connector hole for receiving said threads of said bolt, and
(b) a shoulder for clamping said head between said shoulder and said second end of said shaft and wherein said interior threads of said connector are threadable with said exterior threads of said shaft and said pin includes internal pin threads at one end for engagement with said bolt threads.

6. A tool as claimed in claim 5 wherein said handle includes an exterior rubber coating.

7. A tool as claimed in claim 6 wherein said handle includes a bore there through for slideably receiving said shaft.

8. A tool as claimed in claim 7 including inhibiting means in the vicinity of said second end to inhibit removal of said handle from said shaft.

9. A tool as claimed in claim 8 wherein said inhibiting means comprises a collar removably securable to said shaft.

10. A tool as claimed in claim 8 wherein said inhibiting means comprises shoulder.

11. A tool as claimed in claim 10 wherein said connector is knurled.

12. A tool as claimed in claim 11 wherein said stop comprises:
(a) a cylindrical body having a bore there through;
(b) a first opening and a second opening, said first opening being larger than said second opening;
(c) said second opening having a shoulder adapted to receive a bolt for securing said stop to said shaft.

13. A method of extracting a dowel from a hole, said dowel having an internally threaded portion comprising the steps of:
(a) selecting a bolt having a head and exterior threads capable of engagement with said internally threaded dowel;
(b) securing said bolt to a tool having a shaft and slideable hammer, said shaft having a stop at one end and an externally threaded second end engageable with a connector, said connector clamping said head of said bolt to said second end;
(c) inserting said external threads of said bolt into said hole for engagement with said internal threads of said dowel;
(d) sliding said handle against said stop repeatedly for withdrawing said dowel from said hole.

14. A method as claimed in claim 13 wherein said holes are located in a mould and said tool extracts said dowels from said mould.

15. A method as claimed in claim 14 wherein said selecting steps comprises selecting a bolt from a group of bolts having a plurality of different sized threads and head sizes.

16. A method as claimed in claim 15 wherein said tool includes a collar between said threaded second end and said stop to prevent said handle from striking said connector during said striking step.

17. A method of removing an insert block from a die mould recess, wherein said insert block is located and secured to said mould recess by means of a connecting bolt extending through aligned threaded holes in said insert block and said die mould, said insert also including withdrawing threaded holes comprising the steps of:
(a) selecting a bolt having an head and an external thread capable of engagement with said withdrawing threaded hole in said insert block;
(b) securing said bolt to a tool having a shaft and slideable hammer, said shaft having a stop at one end and an externally threaded second end engageable with a connector, said connector clamping said head of said bolt to said second end;
(c) inserting said external thread of said bolt into said withdrawing threaded hole in said insert block for engagement with said withdrawing threads of said insert block;
(d) striking said handle against said stop repeatedly for withdrawing said insert so as to remove said insert from said die mould.

18. A method as claimed in claim 17 wherein said insert block includes at least two of said holes and said connecting bolts, and said insert block is removed from said die mould by using two said tools engaged with two said connecting bolts respectively substantially simultaneously.

19. A method as claimed in claim 18 wherein said select ion stage comprises selecting a bolt from a group of bolts having a plurality of different sized threads and head sizes.

20. A method as claimed in claim 19 wherein said hole in said die recess is a blind hole.
